(19) United States
(12) Patent Application Publication
(10) Pub. No.: US 2014/0087350 A1
(43) Pub. Date: Mar. 27, 2014

(54) INTERACTIVE TEST PREPARATION PLATFORM

(71) Applicant: Patrick Norman, Washington, DC (US)

(72) Inventor: Patrick Norman, Washington, DC (US)

(21) Appl. No.: 13/624,574

(22) Filed: Sep. 21, 2012

(51) Int. Cl. G09B 7/00

(52) U.S. Cl. CPC G09B 7/00
USPC 434/350

(57) ABSTRACT

An interactive test preparation platform that provides test problems and solutions in an interactive and enhanced manner. For example, the platform can provide an interactive problem and solution user interface that presents solution notations across different selectable problem screens in a manner that enhances the user's understanding of the problem and solution. The platform can enable the user to launch via the user interface multiple videos that explain the solutions to a particular problem in an efficient and bandwidth sensitive manner. The platform can also provide a navigation user interface that enables a user to locate items of interest in a quick and efficient manner by dynamically ordering the items in response to a selected item characteristic.

### FIELD OF THE DISCLOSURE

This relates to educational instruction, including providing test problems and solutions in an interactive and enhanced manner.

### BACKGROUND

Several challenges exist in providing effective educational instruction, especially test preparation instruction for standardized tests such as the Law School Admission Test (LSAT). Classroom instruction can be ineffective because an instructor is simply unable to proceed at a pace that suits each individual student in a class. Similarly, instructional materials can be ineffective because printed problems followed by printed solutions on separate pages makes it difficult for students to quickly understand a problem and the process by which the problem can be solved.

### SUMMARY

An interactive test preparation platform that provides test problems and solutions in an interactive and enhanced manner is disclosed. By providing educational instruction through a user interface that quickly and efficiently allows a user to view how a problem is solved, the user is better able to learn at his or her own pace yet quickly understand a problem and the process by which the problem can be solved.

For example, the platform can provide an interactive problem and solution user interface that presents solution notations across different selectable problem screens in a manner that enhances the user's understanding of the problem and solution. The platform can enable the user to launch via the user interface multiple videos that explain the solutions to a particular problem in an efficient and bandwidth sensitive manner. The platform can also provide a navigation user interface that enables a user to locate items of interest in a quick and efficient manner by dynamically ordering the items in response to a selected item characteristic.

### BRIEF DESCRIPTION OF THE DRAWINGS

FIG. 1 illustrates an example of a test preparation platform architecture.

FIG. 2 illustrates an example of an interactive problem and solution user interface process.

FIG. 3 illustrates an example of a general interactive problem and solution user interface.

FIGS. 4-17 illustrate examples of a specific interactive problem and solution user interface.

FIG. 18 illustrates a video launching process.

FIG. 19 illustrates an example of a video launching user interface.

FIG. 20 illustrates an example of a navigation user interface process.

FIGS. 21-23 illustrate an example of a navigation user interface.

FIG. 24 is a block diagram of an example of a computing device.

### DETAILED DESCRIPTION

The present disclosure is directed to an interactive test preparation platform that provides test problems and solutions in an interactive and enhanced manner. Although the embodiments disclosed herein describe test problems and solutions in the context of standardized testing, the test preparation platform is not so limited and can be used to provide test problems and solutions for any educational content, such as school or university coursework, in accordance with the teachings of the present disclosure.

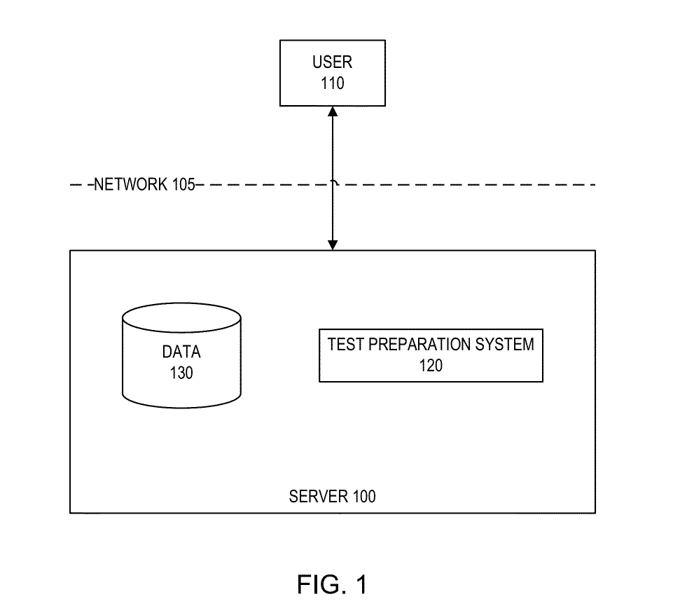

FIG. 1 illustrates an example of a test preparation platform architecture. In the illustrated embodiment, server 100 can comprise one or more servers deploying the test preparation platform of the present disclosure, which can comprise the functionality a web site or other online platform accessible via network 105. Server 100 is accessible via network 105 to one or more client devices, such as, for example, user 110, which can be operated by a user of the test preparation platform (hereinafter referred to as “the platform”). In other embodiments, the platform can be deployed locally on a client device, such as user 110, without requiring access to a network.

Server 100 can be coupled with system components such as test preparation system 120 and data components such as data 130. Test preparation system 120 can comprise the programming that embodies the functionality of the platform. Data 130 can comprises any data required by the platform in order to operate effectively, such as account data comprising users' account information and instructional materials comprising static and dynamic (e.g., video) content corresponding to test problems and solutions, for example.

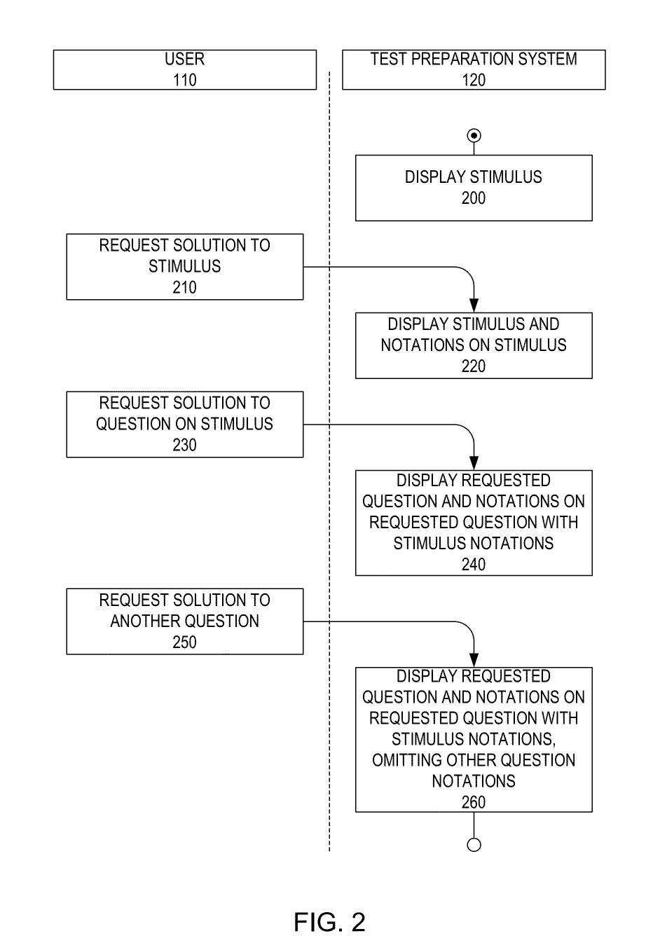

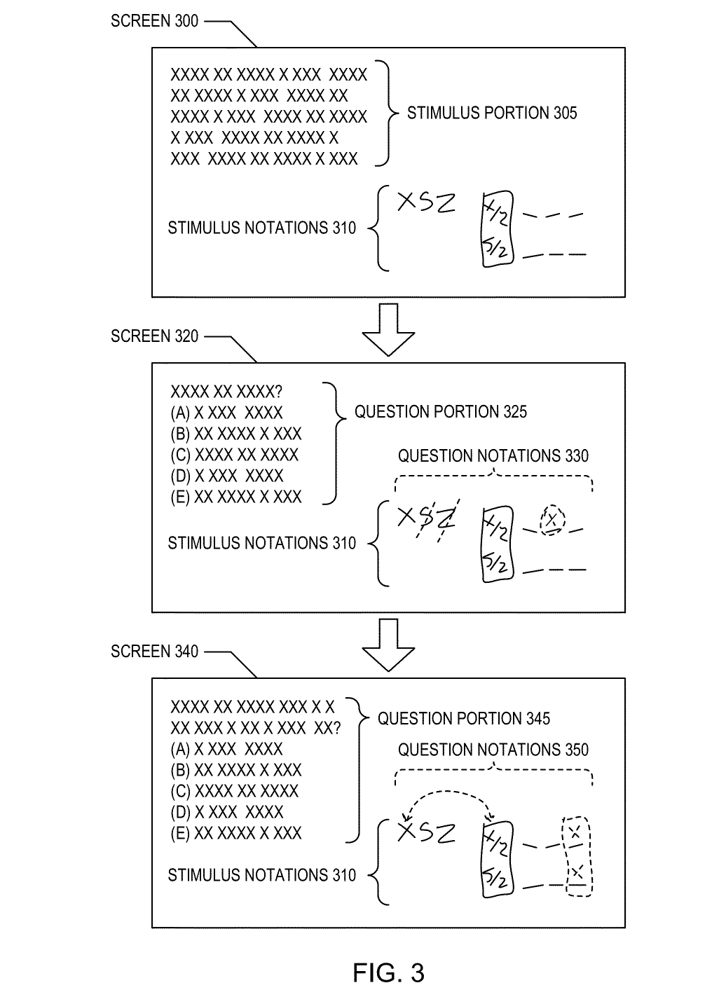

FIGS. 2 and 3 illustrate an example of an interactive problem and solution user interface process and user interface, respectively. As shown in FIGS. 2 and 3, the platform can provide an interactive problem and solution user interface that presents solution notations across different selectable problem screens in a manner that enhances the user's understanding of the problem and solution. The term screen is not limited to any particular type of user interface construct, but rather generally refers to any user interface construct capable of providing a display area for rendering display data.

For example, a test problem can be composed of various portions, such as a stimulus (e.g., a setup section) and multiple questions based on the stimulus. With respect to this type of test problem, as shown in FIG. 2 test preparation system 120 can display the stimulus (block 200) to user 110. In response to a request by user 110 to provide a solution to the stimulus (block 210), test preparation system 120 can display to user 110 the stimulus along with notations based on the stimulus (block 220). A notation can refer to any type of marking, such as a number, character or symbol, and a set of notations refers to one or more notations. The set of notations displayed along with the stimulus can comprise a deconstruction of the stimulus of the problem.

In response to a request by user 110 to provide a solution to a question about the stimulus (block 230), test preparation system 120 can display to user 110 the requested question along with notations based on the question in addition to the previously displayed notations based on the stimulus (block 240). For example, the notations based on the question can comprise a deconstruction of the notations based on the stimulus in order to provide the solution to the question. To present these notations to user 110 in a manner that can facilitate understanding of the notations and the problem, the notations based on the stimulus can thus be carried over from the prior display and one or more of the notations based on the question can be superimposed on the notations based on the stimulus.

In response to a request by user 110 to provide a solution to another question about the stimulus (block 250), test preparation system 120 can display to user 110 the requested question along with notations based on the requested question in addition to the previously displayed notations based on the stimulus (block 260). However, test preparation system 120 can omit from this display the previously displayed notations based on the prior question. In this manner, the user is not presented with unnecessary information that is not relevant to the particular question at hand.

FIG. 3 illustrates an example of a user interface according to the process of FIG. 2. For example, as shown in FIG. 3 test preparation system 120 can display screen 300 comprising stimulus portion 305 of a problem along with stimulus notations 310 in response to a request to provide a solution to stimulus portion 305. While the problem can be displayed in printed form, notations based on the problem can be displayed in printed or handwritten form. In the embodiments described herein, notations are provided in handwritten form to facilitate the user's understanding of the problem and solution.

Returning to FIG. 3, in response to a request to provide a solution to question portion 325 of the problem, test preparation system 120 can subsequently display screen 320 comprising question portion 325 along with question notations 330 (represented in broken lines for ease of illustration) superimposed on stimulus notations 310. In order to assist the user is distinguishing between the different sets of notations, visual effects, such as line color, associated with each of the different sets of notations can vary. For example, stimulus notations 310 can be displayed in one color, such as blue, while question notations 330 can be displayed in a different color, such as red.

And in response to a request to provide a solution to another question portion of the problem, question portion 345, test preparation system 120 can subsequently display screen 340 comprising question portion 345 along with question notations 350 (represented in broken lines for ease of illustration) superimposed on stimulus notations 310 and without question notations 330.

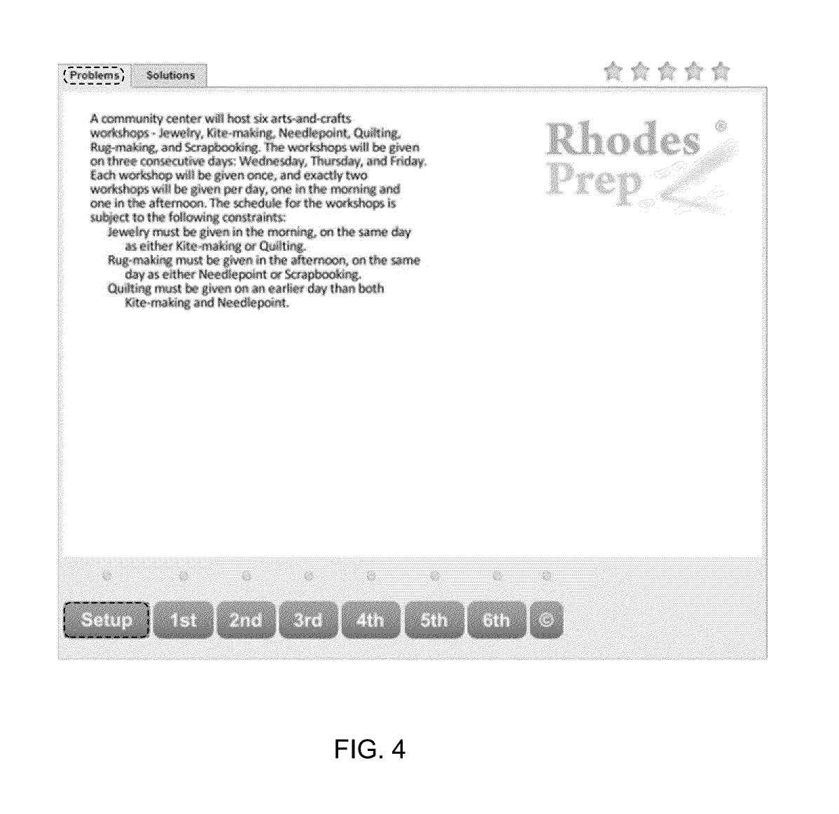

FIGS. 4-17 illustrate examples of a user interface relating to a specific interactive problem and solution. The screens associated with the user interface in the illustrated embodiment can share a common screen size and the individual screens can be displayed independently of each other (i.e., one screen replaces the other in the same display space). The screens can comprise a “Problems” and “Solutions” tab, in addition to buttons comprising the different portions of the problem, such as “Setup” (associated with the stimulus), “1st” (associated with a first question about the stimulus), “2nd” (associated with a second question about the stimulus), “3rd” (associated with a third question about the stimulus), “4th” (associated with a fourth question about the stimulus), “5th” (associated with a fifth question about the stimulus), and “6th” (associated with a sixth question about the stimulus).

FIGS. 4-10 illustrate screens that can be displayed by test preparation system 120 when the “Problems” tab is selected, for example by a user clicking on the tab. With the “Problems” tab selected, test preparation system 120 can display the portions of the problem associated with the currently selected button without any notations. If no button is selected, test preparation system 120 can display any suitable screen by default, such as the “Setup” portion of the problem or a copyright notice (which can be displayed in response to selection of the “©” button). With the “Problems” tab selected, a user can toggle through the portions of the problem without notations or solutions by clicking the corresponding buttons on the screen.

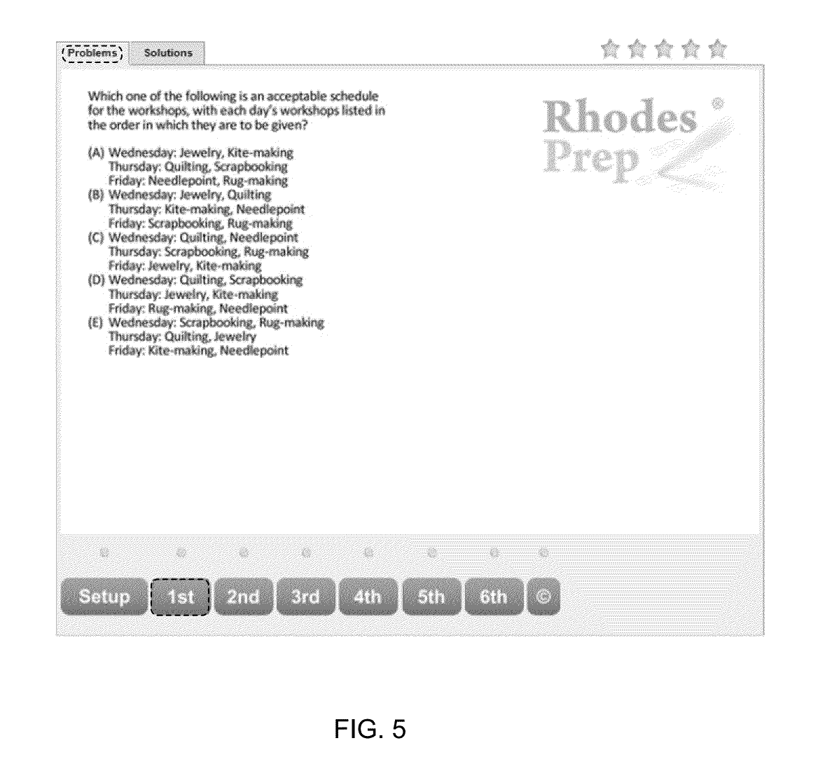

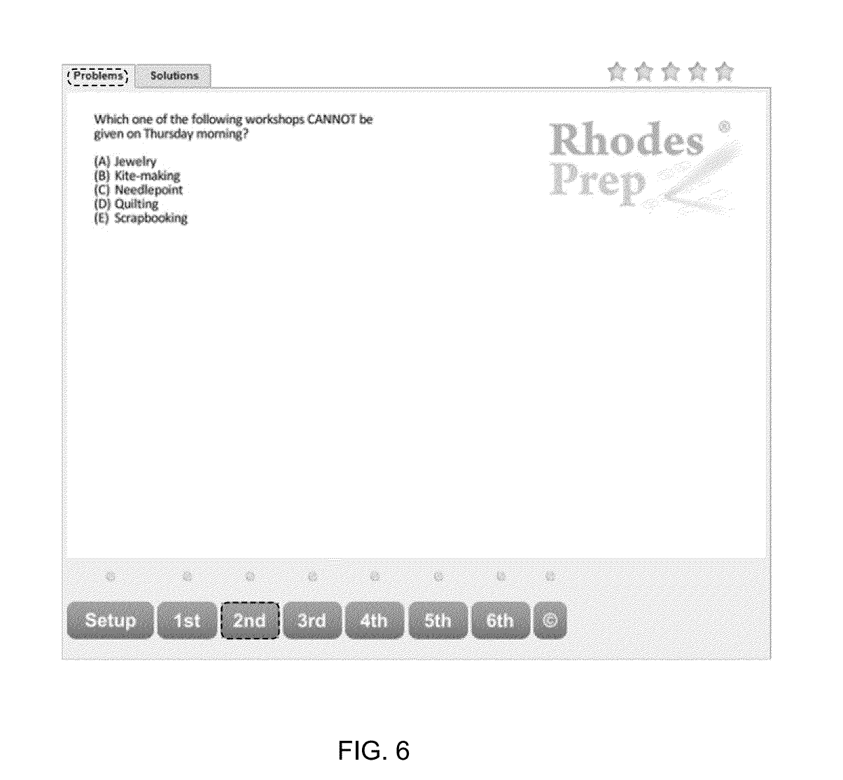

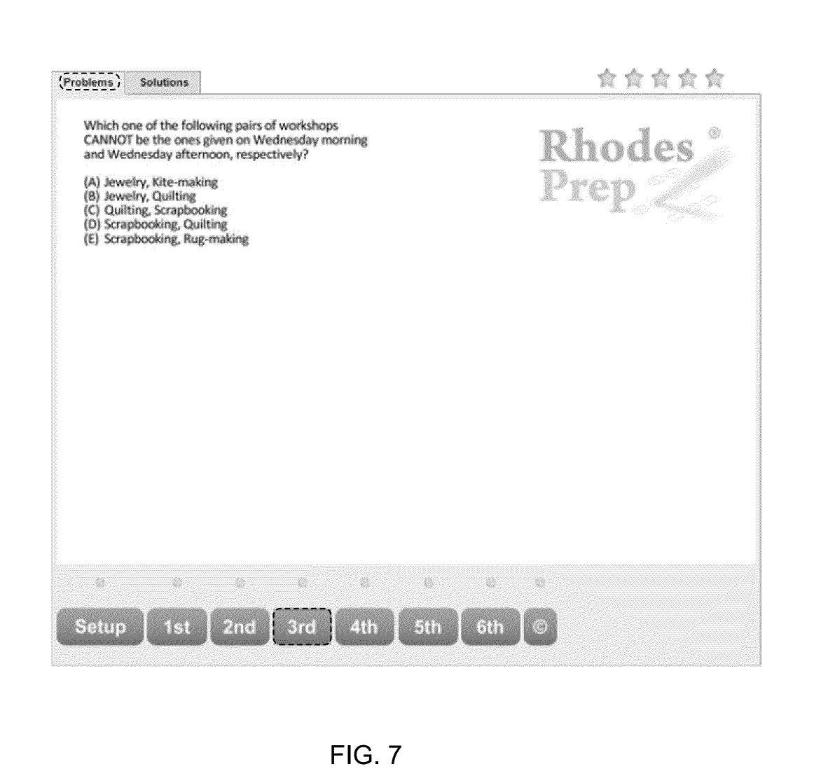

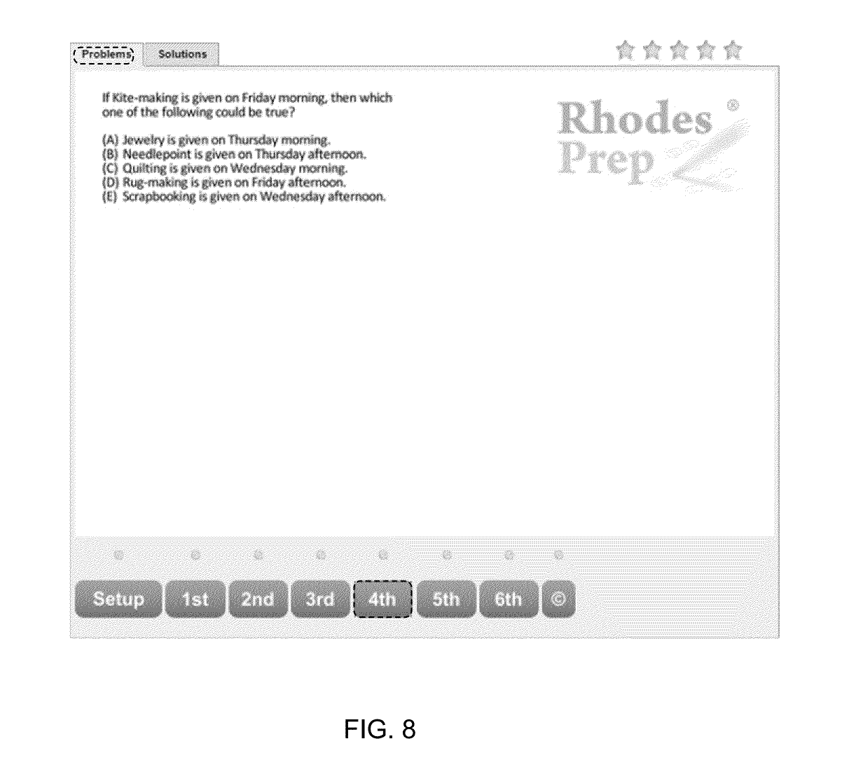

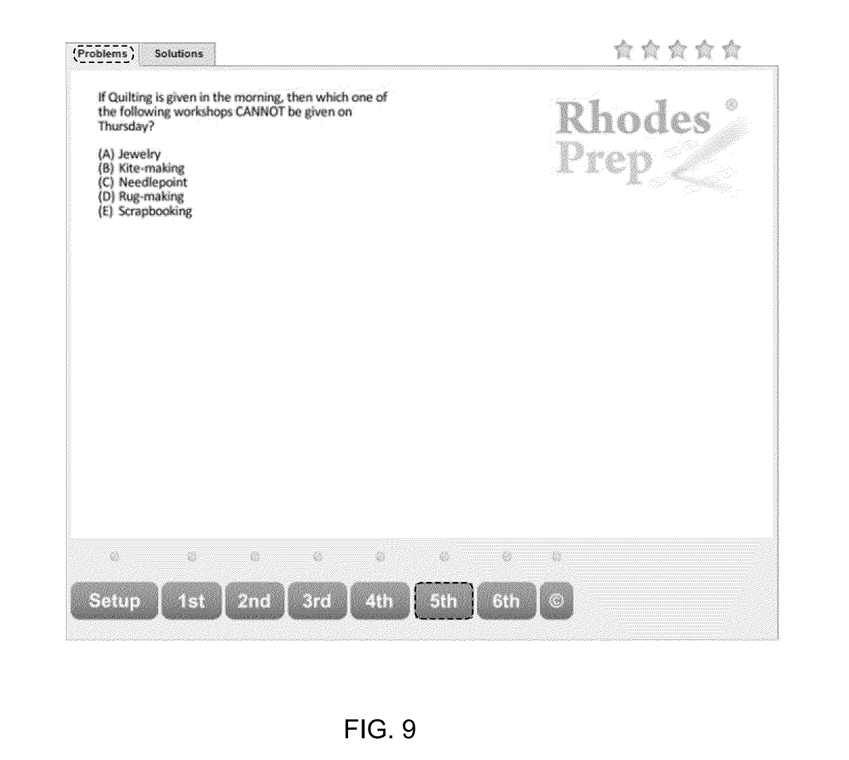

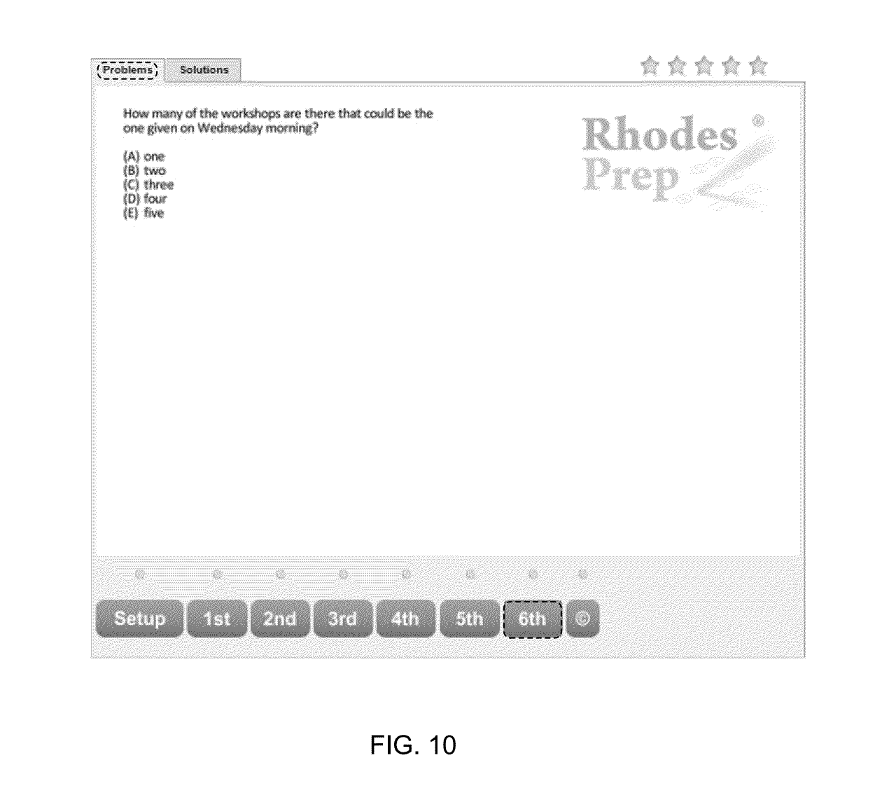

Thus, FIG. 4 shows a screen comprising the stimulus of the problem rendered by test preparation system 120 in response to selection of the “Setup” button. FIG. 5 shows a screen comprising the first question of the problem rendered by test preparation system 120 in response to selection of the “1st” button. FIG. 6 shows a screen comprising the second question of the problem rendered by test preparation system 120 in response to selection of the “2nd” button. FIG. 7 shows a screen comprising the third question of the problem rendered by test preparation system 120 in response to selection of the “3rd” button. FIG. 8 shows a screen comprising the fourth question of the problem rendered by test preparation system 120 in response to selection of the “4th” button. FIG. 9 shows a screen comprising the fifth question of the problem rendered by test preparation system 120 in response to selection of the “5th” button. FIG. 10 shows a screen comprising the sixth question of the problem rendered by test preparation system 120 in response to selection of the “6th” button.

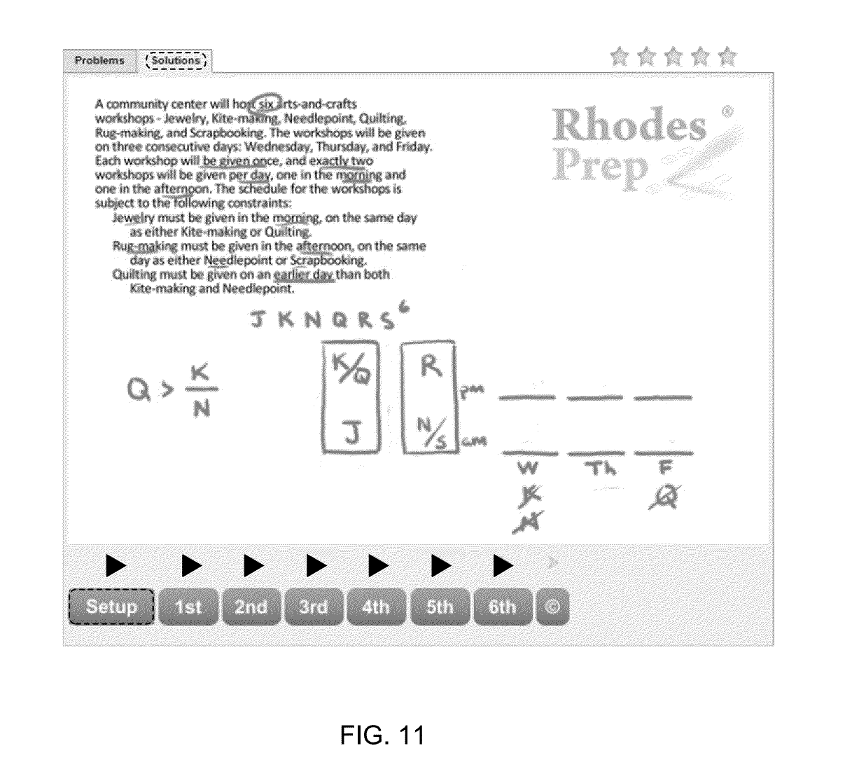

FIGS. 11-17 illustrate screens that can be displayed by test preparation system 120 when the “Solutions” tab is selected, for example by a user clicking on the tab. With the “Solutions” tab selected, test preparation system 120 can display the portions of the problem associated with the currently selected button along with notations solving that portion of the problem. If no button is selected, test preparation system 120 can display any suitable screen by default, such as the “Setup” portion of the problem with notations or the copyright notice. With the “Solutions” tab selected, a user can toggle through the portions of the problem with notations and solutions by clicking the corresponding buttons on the screen.

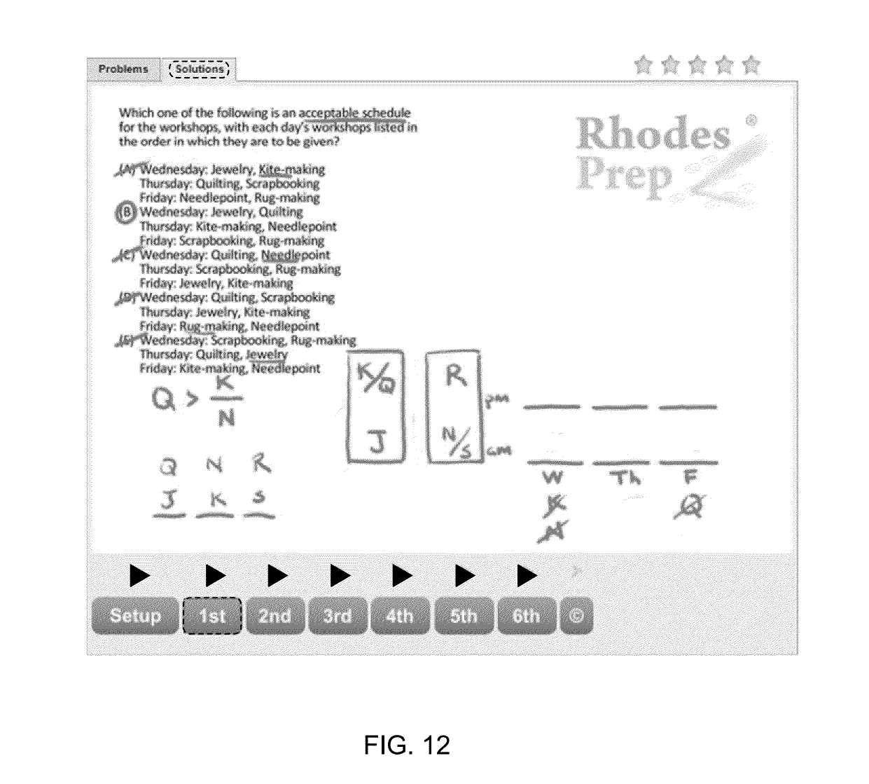

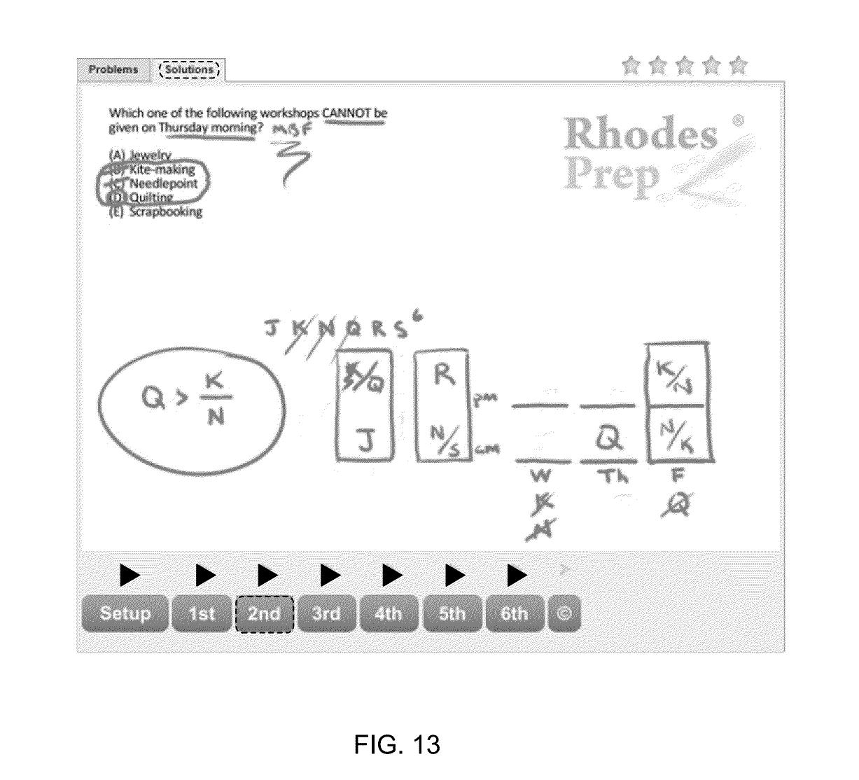

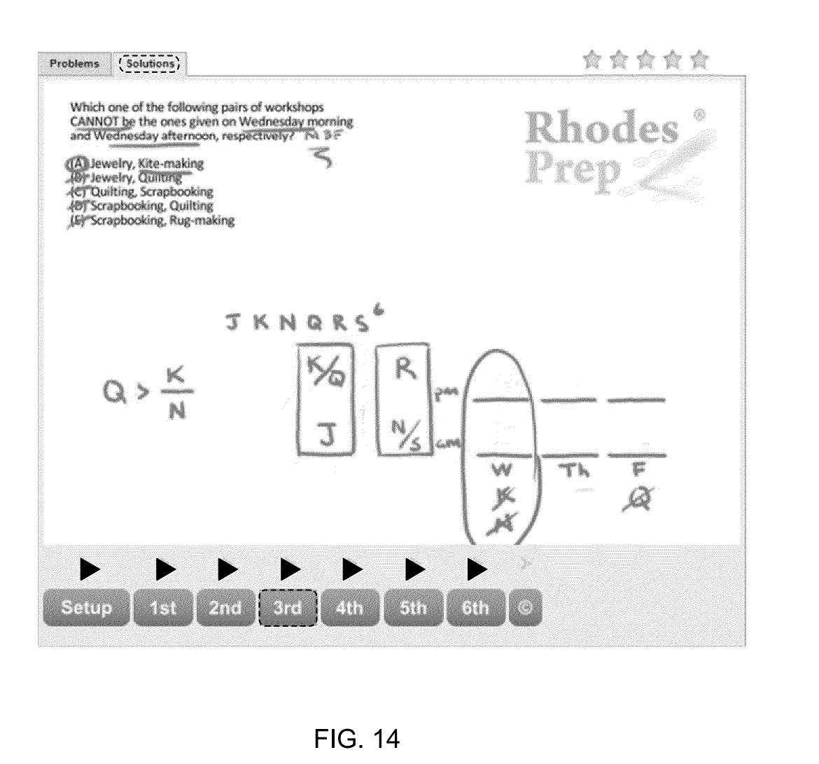

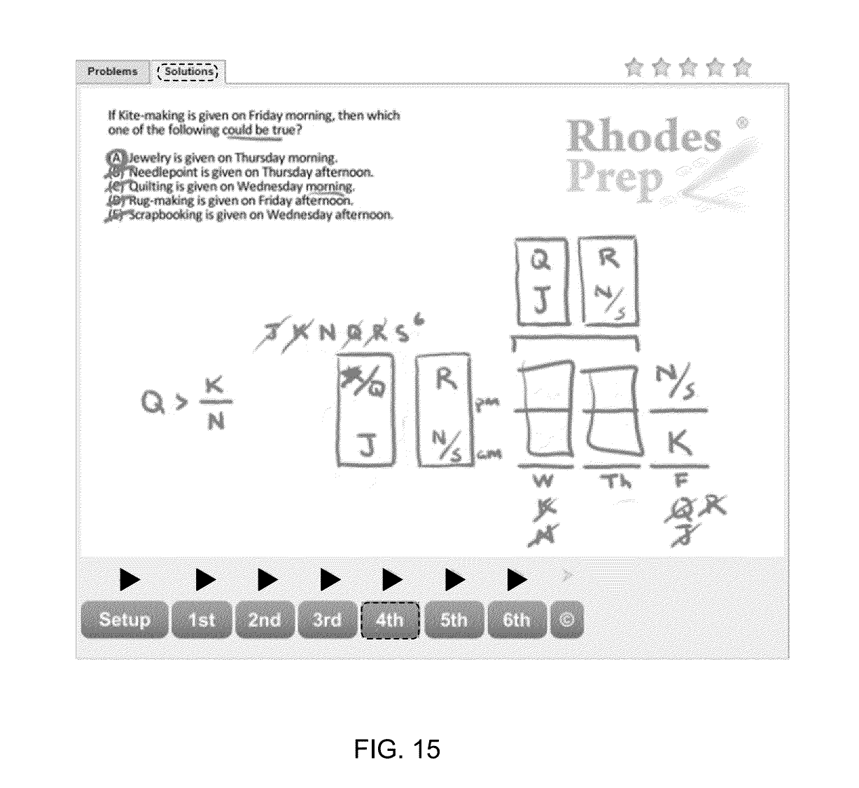

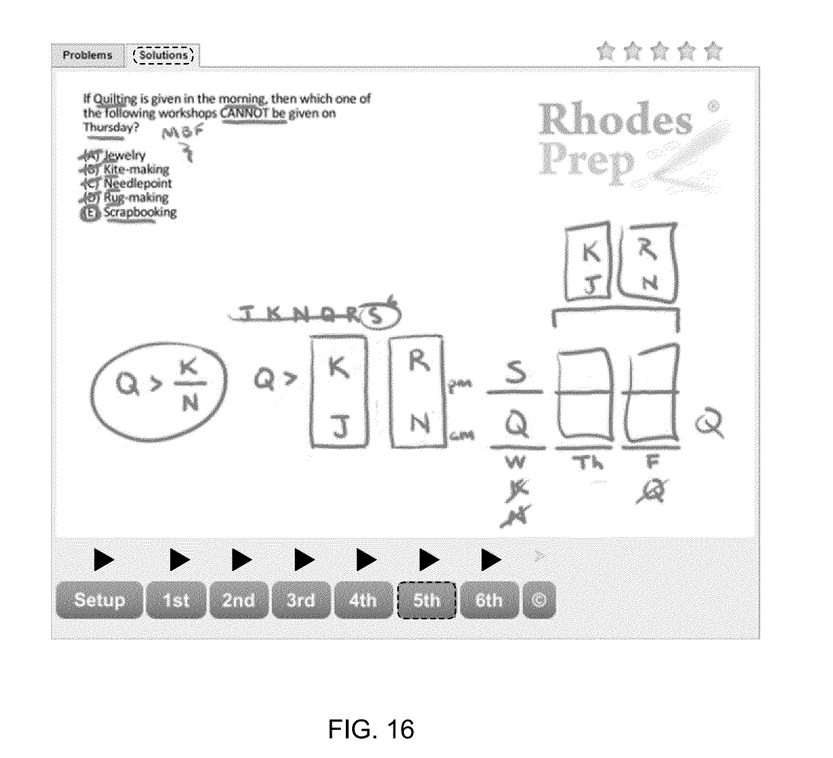

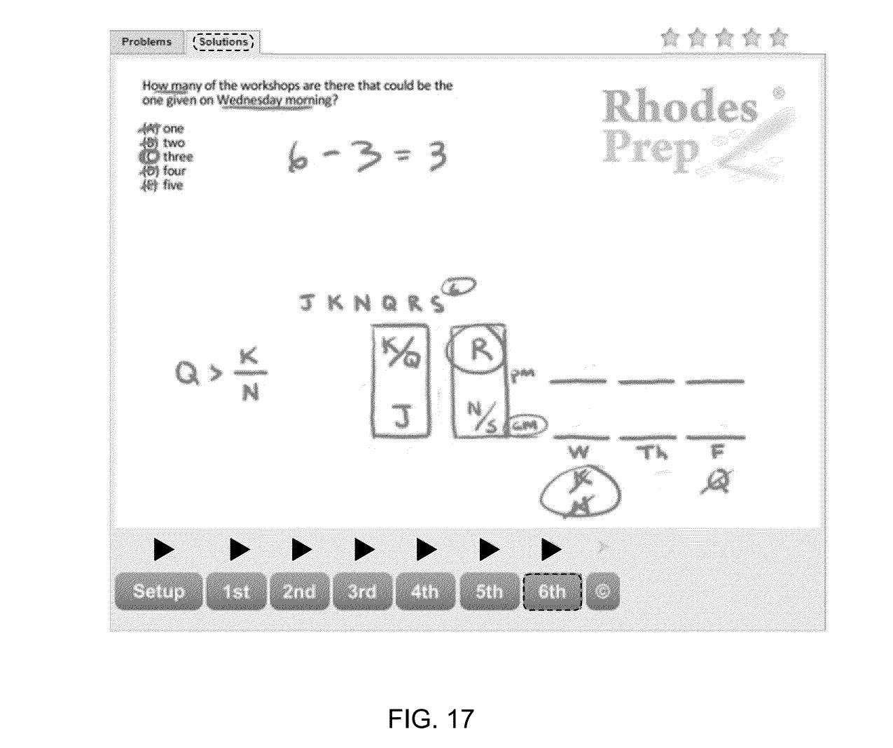

Thus, FIG. 11 shows a screen comprising the stimulus of the problem and notations based on the stimulus rendered by test preparation system 120 in response to selection of the “Setup” button. FIG. 12 shows a screen comprising the first question of the problem and notations based on the stimulus and the first question rendered by test preparation system 120 in response to selection of the “1st” button. FIG. 13 shows a screen comprising the second question of the problem and notations based on the stimulus and the second question rendered by test preparation system 120 in response to selection of the “2nd” button. FIG. 14 shows a screen comprising the third question of the problem and notations based on the stimulus and the third question rendered by test preparation system 120 in response to selection of the “3rd” button. FIG. 15 shows a screen comprising the fourth question of the problem and notations based on the stimulus and the fourth question rendered by test preparation system 120 in response to selection of the “4th” button. FIG. 16 shows a screen comprising the fifth question of the problem and notations based on the stimulus and the fifth question rendered by test preparation system 120 in response to selection of the “5th” button. FIG. 17 shows a screen comprising the sixth question of the problem and notations based on the stimulus and the sixth question rendered by test preparation system 120 in response to selection of the “6th” button.

It is noted that only some or none of the notations based on a question can be superimposed on the notations based on the stimulus. For example, in FIG. 12, the notations based on the first question comprise the notations that are supplemental to those carried over from the screen shown in FIG. 11. In particular, the notations based on the first question in FIG. 12 comprise the notations superimposed on the printed question portion via circling, underlining and slashes and the notations located in the lower left hand corner of the screen. None of these notations are superimposed on the carried over notations based on the stimulus. However, in FIG. 13, for example, some of the notations based on the question are superimposed on the notations based on the stimulus (e.g., the rectangle and characters/slashes contained therein on the right side of the screen).

The notations can be constructed in any manner suitable to facilitate the user's understanding of the problem and solution. For example, in FIG. 11, the stimulus pertains to various workshops and scheduling criteria while the notations based on the stimulus comprise deconstructing the workshops and scheduling criteria of the stimulus into letters and graphical relationships (e.g., “J” represents “Jewelry,” “K” represents “Kite-making,” “W” represents “Wednesday”, “Th” represents “Thursday,” etc.). In FIG. 12, the question asks which of the provided choices is an acceptable schedule based on the stimulus, and the notations based on the first question comprise deconstructing choice B into letters and graphical relationships which can be compared to the previously deconstructed workshop and scheduling criteria to understand the solution. FIGS. 13-17 are constructed in a similar manner.

It is noted that in the illustrated embodiment, while notations based on the stimulus are carried over for each question, notations pertaining to other questions are excluded to facilitate the user's understanding of the material. It is also noted that not all notations based on the stimulus are carried over, such as those notations superimposed on the printed stimulus portion via circling and underlining, because those printed portions are not carried over to the question screens. However, in other embodiments the printed portions of the stimulus can be carried over to the question screens, along with or without the associated notations.

The notations can be displayed statically or dynamically. As shown in FIGS. 11-17, the notations can be displayed statically as images, and the notations based on the stimulus can be displayed in a common (i.e., the same) location among the screens to help facilitate the user's understanding of the material.

Test preparation system 120 can also display the notations dynamically in a video format. For example, if the user has difficulty understanding how the notations solve or deconstruct the problem, test preparation system 120 can display in the screen a video explaining how they solve or deconstruct the problem. The video can be designed in any suitable manner, such as showing the notations being made while orally explaining what the notations mean and how they solve or deconstruct the problem. Test preparation system 120 can provide this functionality by exposing a button for each portion of the problem to launch a video pertaining to that portion. As shown in FIGS. 11-17, play symbols can be provided near the buttons associated with the particular question portions of the problem and can be configured to launch a video associated with the corresponding question portion when selected (e.g., clicked).

In networked embodiments, providing to user 110 a video for each problem can have a detrimental effect on network performance. This can occur when the playing of the video and the navigation functionality of the user interface providing the video (e.g., the buttons which launch the video) are provided in the same software component, such as a Flash object. To overcome this limitation, test preparation system 120 can separate the playing of the video and the navigation functionality of the user interface providing the video to improve performance. This separation can also provide a better looking user interface for navigating the screens since the user interface design is not constrained by potentially limited user interface tools supported by the software component that plays the video.

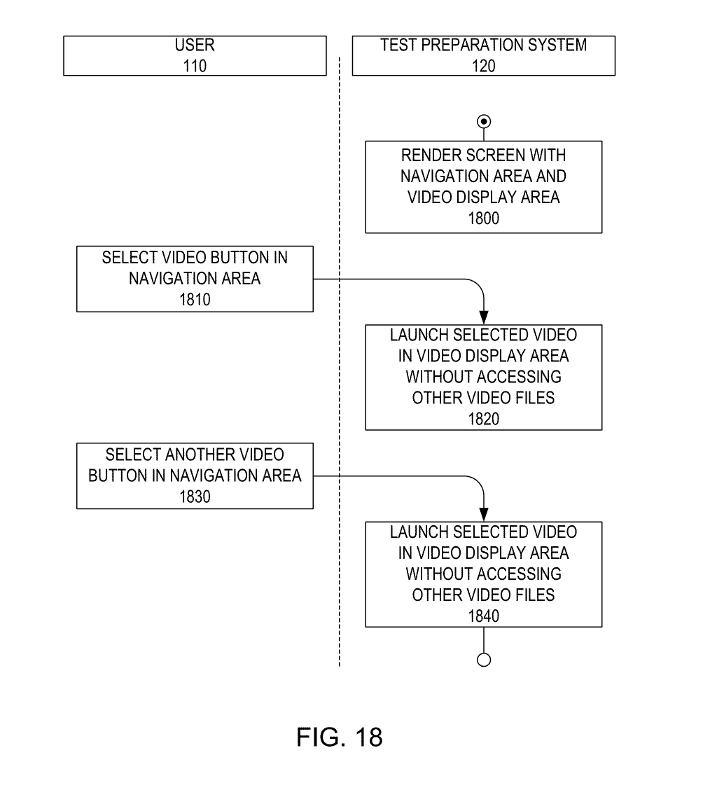

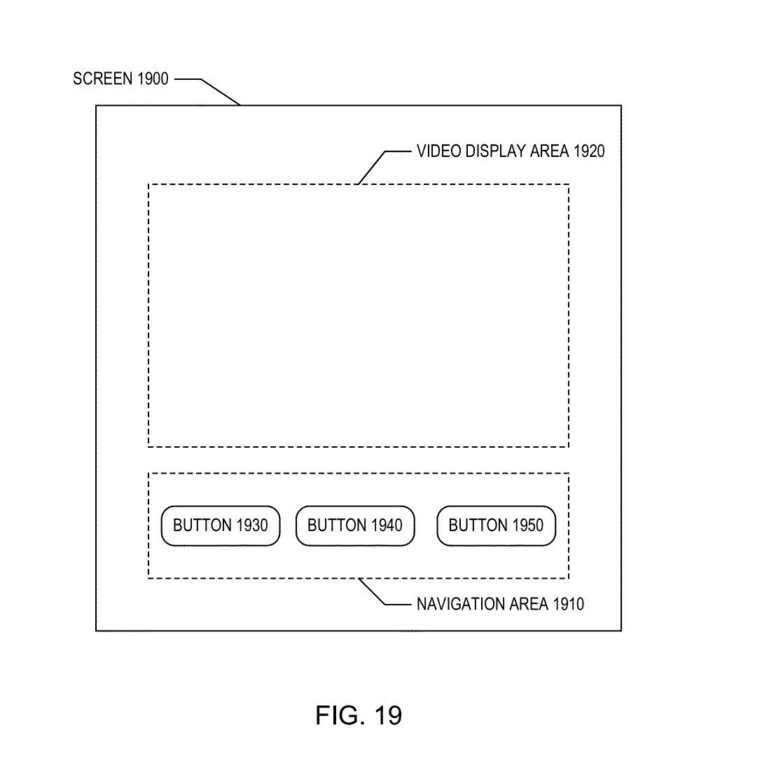

FIGS. 18 and 19 illustrate an example of a video launching process and user interface, respectively. As shown in FIGS. 18 and 19, the platform can enable the user to launch via the user interface multiple videos that explain the solutions to a particular problem in an efficient and bandwidth sensitive manner.

As shown in FIG. 18, test preparation system 120 can render a screen with a navigation area and a video display area (block 1800). An example of this is shown in FIG. 19, which depicts screen 1900 with navigation area 1910 and video display area 1920. Navigation area 1910 can comprise multiple buttons such as button 1930, button 1940 and button 1950. These buttons can be arranged in any suitable manner, such as linearly, in navigation area 1910 and each of the buttons can be associated with a distinct video file. Video display area 1920 can comprise a common (i.e., the same) area to play each of the video files.

In response to a selection by the user of one of the rendered buttons (block 1810), test preparation system 120 can launch the video file associated with the selected button in video display area 1920 without accessing the video files associated with the other of the rendered buttons (block 1820). This can be achieved by launching a video file associated with the selected button from one software component (e.g., a Flash object) and rendering the multiple buttons from a different software component (e.g., the html page rendering the user interface) that is not within the first software component.

Returning to FIG. 18, in response to a selection by the user of another one of the rendered buttons (block 1830), test preparation system 120 can launch the video file associated with that selected button in video display area 1920 without accessing the video files associated with the other of the rendered buttons (block 1840) as described above.

The following html code provides an example of the programming that can form the user interface of FIGS. 4-17 with the video launching capability as described above:

<script type=“text/javascript”
src=“/scripts/AR01/201006ARG1.js”></script>
<script type=“text/javascript” src=“/scripts/get_image.js”></script>
<div id=“container”>

<div id=“mainContent”>

<div id=“TabbedPanels1” class=“TabbedPanels”>

<ul class=“TabbedPanelsTabGroup”>

<li class=“TabbedPanelsTab”

tabindex=“0”>Problems</li>

<li class=“TabbedPanelsTab”

tabindex=“0”>Solutions</li>

</ul>
<div class=“TabbedPanelsContentGroup”>

<div class=“TabbedPanelsContent”>

<div id=“imagePlayback” style=“width: 624px; height:416px;”>

<img id=“dx01” src=“/tiles/AR01/201006G1/01756-

201006ARG1/MEIHG8TJ8P.jpg” width=“156” height=“104”>

<img id=“dx02” src=“/tiles/AR01/201006G1/01756-

201006ARG1/PYZTJ00P9M.jpg” width=“156” height=“104”>

<img id=“dx03” src=“/tiles/AR01/201006G1/01756-

201006ARG1/LAQA03Q23S.jpg” width=“156” height=“104”>

<img id=“dx04” src=“/tiles/AR01/201006G1/01756-

201006ARG1/NR0PPWNRA5.jpg” width=“156” height=“104”>

<img id=“dx05” src=“/tiles/AR01/201006G1/01756-

201006ARG1/2WNZ93WOVC.jpg” width=“156” height=“104”>

<img id=“dx06” src=“/tiles/AR01/201006G1/01756-

201006ARG1/RQ4R98MVRO.jpg” width=“156” height=“104”>

<img id=“dx07” src=“/tiles/AR01/201006G1/01756-

201006ARG1/YIZH458FZV.jpg” width=“156” height=“104”>

<img id=“dx08” src=“/tiles/AR01/201006G1/01756-

201006ARG1/JSMBGH80ZV.jpg” width=“156” height=“104”>

<img id=“dx09” src=“/tiles/AR01/201006G1/01756-

201006ARG1/AND9JE3NVT.jpg” width=“156” height=“104”>

<img id=“dx10” src=“/tiles/AR01/201006G1/01756-

201006ARG1/YlYC3I2N8J.jpg” width=“156” height=“104”>

<img id=“dx11” src=“/tiles/AR01/201006G1/01756-

201006ARG1/U3JQHOD35S.jpg” width=“156” height=“104”>

<img id=“dx12” src=“/tiles/AR01/201006G1/01756-

201006ARG1/VHU5Y3OPQ3.jpg” width=“156” height=“104”>

<img id=“d13” src=“/tiles/AR01/201006G1/01756-

201006ARG1/4EPNLUA5OR.jpg” width=“156” height=“104”>

<img id=“dx14” src=“/tiles/AR01/201006G1/01756-

201006ARG1/FLJBW7EBPM.jpg” width=“156” height=“104”>

<img id=“dx15” src=“/tiles/AR01/201006G1/01756-

201006ARG1/GON3NJNHKK.jpg” width=“156” height=“104”>

<img id=“dx16” src=“/tiles/AR01/201006G1/01756-

201006ARG1/3H67Z9F7GC.jpg” width=“156” height=“104”>
</div>
<button class=“button01 ds”></button>
<button class=“button01 dn”></button>
<button class=“button01 dn”></button>
<button class=“button01 dn”></button>
<button class=“button01 dn”></button>
<button class=“button01 dn”></button>
<button class=“button01 dn”></button>
<button class=“button01 dc”></button>
<button class=“button01” id=“setup”
onclick=“displayProblem00( )”></button>
<button class=“button01” id=“q1”
onclick=“displayProblem01( )”></button>
<button class=“button01” id=“q2”
onclick=“displayProblem02( )”></button>
<button class=“button01” id=“q3”
onclick=“displayProblem03( )”></button>
<button class=“button01” id=“q4”
onclick=“displayProblem04( )”></button>
<button class=“button01” id=“q5”
onclick=“displayProblem05( )”></button>
<button class=“button01” id=“q6”
onclick=“displayProblem06( )”></button>
<button class=“button01” id=“copy”
onclick=“displayCopyright01( )”></buttonx/div>
<div class=“TabbedPanelsContent”>
<div id=“videoPlayback” style=“width: 624px; height:416px;”>

<img id=“lx01” src=“” width=“156” height=“104”>
<img id=“lx02” src=“” width=“156” height=“104”>
<img id=“lx03” src=“” width=“156” height=“104”>
<img id=“lx04” src=“” width=“156” height=“104”>
<img id=“lx05” src=“” width=“156” height=“104”>
<img id=“lx06” src=“” width=“156” height=“104”>
<img id=“lx07” src=“” width=“156” height=“104”>
<img id=“lx08” src=“” width=“156” height=“104”>
<img id=“lx09” src=“” width=“156” height=“104”>
<img id=“lx10” src=“” width=“156” height=“104”>
<img id=“lx11” src=“” width=“156” height=“104”>
<img id=“lx12” src=“” width=“156” height=“104”>
<img id=“lx13” src=“” width=“156” height=“104”>
<img id=“lx14” src=“” width=“156” height=“104”>
<img id=“lx15” src=“” width=“156” height=“104”>
<img id=“lx16” src=“” width=“156” height=“104”>

</div>
<button class=“button01 ps” onclick=‘return
playVideo(“fx00”,“videoPlayback”)’></button>
<button class=“button01 pn” onclick=‘return
playVideo(“fx01”,“videoPlayback”)’></button>
<button class=“button01 pn” onclick=‘return
playVideo(“fx02”,“videoPlayback”)’></button>
<button class=“button01 pn” onclick=‘return
playVideo(“fx03”,“videoPlayback”)’></button>
<button class=“button01 pn” onclick=‘return
playVideo(“fx04”,“videoPlayback”)’></button>
<button class=“button01 pn” onclick=‘return
playVideo(“fx05”,“videoPlayback”)’></button>
<button class=“button01 pn” onclick=‘return
playVideo(“fx06”,“videoPlayback”)’></button>
<button class=“button01 pc” onclick=‘return
playVideo(“fx10”,“videoPlayback”)’></button>
<button class=“button01” id=“setup”
onclick=“displaySolution00( )”></button>
<button class=“button01” id=“q1”
onclick=“displaySolution01( )”></button>
<button class=“button01” id=“q2”
onclick=“displaySolution02( )”></button>
<button class=“button01” id=“q3”
onclick=“displaySolution03( )”></button>
<button class=“button01” id=“q4”
onclick=“displaySolution04( )”></button>
<button class=“button01” id=“q5”
onclick=“displaySolution05( )”></button>
<button class=“button01” id=“q6”
onclick=“displaySolution06( )”></button>
<button class=“button01” id=“copy”
onclick=“displayCopyright02( )”></button>
<div id=“fx00” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F002%2FU6E5JJR4L6&autoPlay=true”></embed></object></di
v>
<div id=“fx01” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F002%2F5N4UQE2UHG&autoPlay=true”></embed></object></di
v>
<div id=“fx02” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F002%2FMEJJWOBGPX&autoPlay=true”></embed></object></di
v>
<div id=“fx03” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F002%2FEEK9FQ651Y&autoPlay=true”></embed></object></di
v>
<div id=“fx04” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F002%2FETT6C3A2HB&autoPlay=true”></embed></object></di
v>
<div id=“fx05” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F002%2FF9QMFSOXW2&autoPlay=true”></embed></object></di
v>
<div id=“fx06” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F002%2FMSFJPCN69G&autoPlay=true”></embed></object></di
v>
<div id=“fx10” style=‘display: none’><object width=“624”
height=“416”><param name=“allowFullScreen” value=“true”></param><embed
src=“http://lsat.rhodesprep.com/osmf/10.1/StrobeMediaPlayback.swf”type=“appli
cation/x-shockwave-flash” allowscriptaccess=“always”
allowfullscreen=“true”width=“624”
height=“416”flashvars=“src=rtmp%3A%2F%2Fec2-23-20-146-195.compute-
1.amazonaws.com%2Fvod%2F000%2FC000000001&autoPlay=true”></embed></object></di
v>
</div></div></div></div></div>

This is a sequencing game. There are six players (workshops) that must be evenly assigned to a sequence of six slots. The sequence is more complicated than usual. It consists of mornings and afternoons across three days. We set up the base by drawing two slots (morning and afternoon) for each of the three days. That creates the needed total of six slots.

We are given indented rules that create two separate buddy blocks. These two buddy blocks potentially include any of the six players. We are also given one indented rule that establishes the relative positioning of three of the six players. These three players are included in both of the buddy blocks. That creates an interesting interaction between the indented rules.

It is enough to note that the interaction between the buddy blocks and the relative positioning rule exists. We do not need to work through all of the implications nor exhaust all of the possibilities that are created. This is a simple sequencing game with six questions. That is all that it is. This should be one of the faster games for us. Do not get unnecessarily bogged down in deep thoughts and complex diagrams.

Two of the questions require us to determine the players that are eliminated from certain positions. Remember that the players that are eliminated from a position are both the players that form our not inferences as well as any players that we affirmatively place in some other position. The video for the second question focuses on this point, but does not mention that Rug-making is affirmatively assigned to the afternoon. The omission does not impact the solution. However, it is good to keep Rug-making in mind when watching the video.

It is noted that the last four paragraphs of the listed code are not rendered in FIGS. 4-17. The “imagePlayback” container comprises the default screen that is rendered when the “Problems” tab is selected, and identifies 16 distinct image files to be tiled together to create the static screen image in an effort to reduce the risk of copying. The “videoPlayback” container comprises the default screen that is rendered when the “Solutions” tab is selected, and similarly identifies 16 distinct image files to be tiled together to create the static screen image in an effort to reduce the risk of copying.

The buttons mapped to the playVideo( ) function calls comprise the play buttons located above the “Setup,” “1st,” “2nd,” “3rd,” “4th,” “5th,” and “6th” buttons associated with the “Solutions” tab shown in FIGS. 11-17. The sources of the video files are identified directly above the last four paragraphs of the listed code (i.e., with respect to identifiers “fx00,” “fx01,” “fx02,” “fx03,” “fx04,” “fx05,” and “fx06”).

The buttons mapped to the displayProblem**( ) function calls comprise the “Setup,” “1st,” “2nd,” “3rd,” “4th,” “5th,” and “6th” buttons associated with the “Problems” tab shown in FIGS. 4-10. The buttons mapped to the displaySolution**( ) function calls comprise the “Setup,” “1st,” “2nd,” “3rd,” “4th,” “5th,” and “6th” buttons associated with the “Solutions” tab shown in FIGS. 11-17. These functions comprise javascript functions defined in other files. For example, the following is a representative example of the displayProblem**( ) function call definitions:

function displayProblem00( )
{
document.getElementById(“dx01”).src=dx_00_01.src
document.getElementById(“dx02”).src=dx_00_02.src
document.getElementById(“dx03”).src=dx_00_03.src
document.getElementById(“dx04”).src=dx_00_04.src
document.getElementById(“dx05”).src=dx_00_05.src
document.getElementById(“dx06”).src=dx_00_06.src
document.getElementById(“dx07”).src=dx_00_07.src
document.getElementById(“dx08”).src=dx_00_08.src
document.getElementById(“dx09”).src=dx_00_09.src
document.getElementById(“dx10”).src=dx_00_10.src
document.getElementById(“dx11”).src=dx_00_11.src
document.getElementById(“dx12”).src=dx_00_12.src
document.getElementById(“dx13”).src=dx_00_13.src
document.getElementById(“dx14”).src=dx_00_14.src
document.getElementById(“dx15”).src=dx_00_15.src
document.getElementById(“dx16”).src=dx_00_16.src
}

Similarly to the above, the displayProblem**( ) function calls each identify 16 distinct image files to be tiled together to create the static screen image in an effort to reduce the risk of copying. The following is an example of a representative listing that identifies the source files in a displayProblem**( ) function:

dx_00_01=new Image(156,104)
dx_00_01.src=“/tiles/AR01/201006G1/01756-201006ARG1/MEIHG8TJ8P.jpg”
dx_00_02=new Image(156,104)
dx_00_02.src=“/tiles/AR01/201006G1/01756-201006ARG1/PYZTJ00P9M.jpg”
dx_00_03=new Image(156,104)
dx_00_03.src=“/tiles/AR01/201006G1/01756-201006ARG1/LAQA03Q23S.jpg”
dx_00_04=new Image(156,104)
dx_00_04.src=“/tiles/AR01/201006G1/01’756-201006ARG1/NR0PPWNRA5.jpg”
dx_00_05=new Image(156,104)
dx_00_05.src=“/tiles/AR01/201006G1/01756-201006ARG1/2WNZ93WOVC.jpg”
dx_00_06=new Image(156,104)
dx_00_06.src=“/tiles/AR01/201006G1/01756-201006ARG1/RQ4R98MVRO.jpg”
dx_00_07=new Image(156,104)
dx_00_07.src=“/tiles/AR01/201006G1/01756-201006ARG1/YIZH458FZV.jpg”
dx_00_08=new Image(156,104)
dx_00_08.src=“/tiles/AR01/201006G1/01756-201006ARG1/JSMBGH80ZV.jpg”
dx_00_09=new Image(156,104)
dx_00_09.src=“/tiles/AR01/201006G1/01756-201006ARG1/AND9JE3NVT.jpg”
dx_00_10=new Image(156,104)
dx_00_10.src=“/tiles/AR01/201006G1/01756-201006ARG1/Y1YC3I2N8J.jpg”
dx_00_11=new Image(156,104)
dx_00_11.src=“/tiles/AR01/201006G1/01756-201006ARG1/U3JQHOD35S.jpg”
dx_00_12=new Image(156,104)
dx_00_12.src=“/tiles/AR01/201006G1/01756-201006ARG1/VHU5Y3OPQ3.jpg”
dx_00_13=new Image(156,104)
dx_00_13.src=“/tiles/AR01/201006G1/01756-201006ARG1/4EPNLUA5OR.jpg”
dx_00_14=new Image(156,104)
dx_00_14.src=“/tiles/AR01/201006G1/01756-201006ARG1/FLJBW7EBPM.jpg”
dx_00_15=new Image(156,104)
dx_00_15.src=“/tiles/AR01/201006G1/01756-201006ARG1/GON3NJNHKK.jpg”
dx_00_16=new Image(156,104)
dx_00_16.src=“/tiles/AR01/201006G1/01756-201006ARG1/3H67Z9F7GC.jpg”

The displaySolution**( ) function calls are programmed in a similar manner, except that “lx” replaces “dx” in the identifier names and the image files are in a different format (.png rather than .jpg).

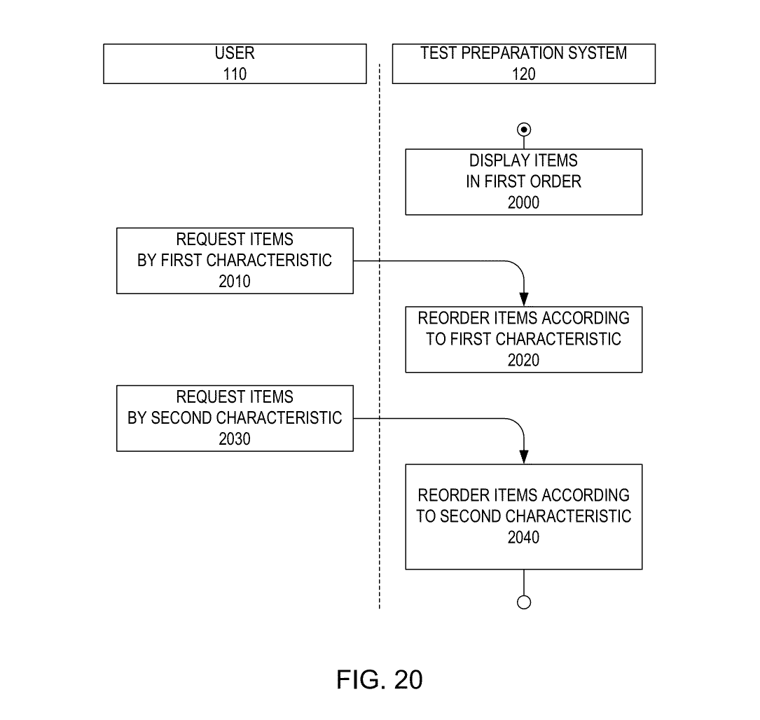

FIGS. 20-23 illustrate an example of a navigation user interface process and navigation user interface, respectively. As shown in FIGS. 20-23, the platform can provide a navigation user interface that enables a user to locate items of interest, such as instructional materials, in a quick and efficient manner by dynamically ordering the items in response to a selected item characteristic.

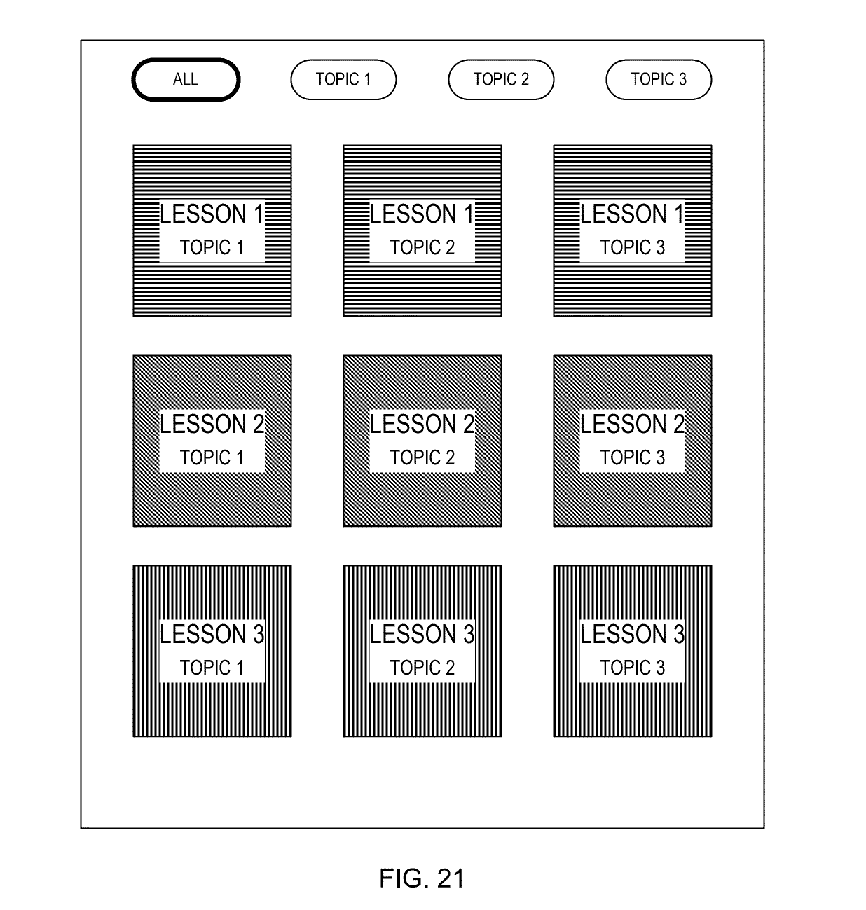

As shown in FIG. 20, test preparation system 120 can display items in a first order (block 2000). An example of this is shown in FIG. 21, which depicts a screen comprising multiple buttons in a first area of the screen (e.g., the three “topic” buttons located at the top of the screen) and multiple selectable items in a second area of the screen (e.g., the nine lesson icons located below the four buttons at the top of the screen). Each of the topic buttons can be associated with a distinct characteristic (e.g., “topic 1,” “topic 2” or “topic 3”) associated with one or more of the selectable items. The selectable items are initially ordered based on lesson number in the illustrated embodiment but can be initially ordered based on any characteristic.

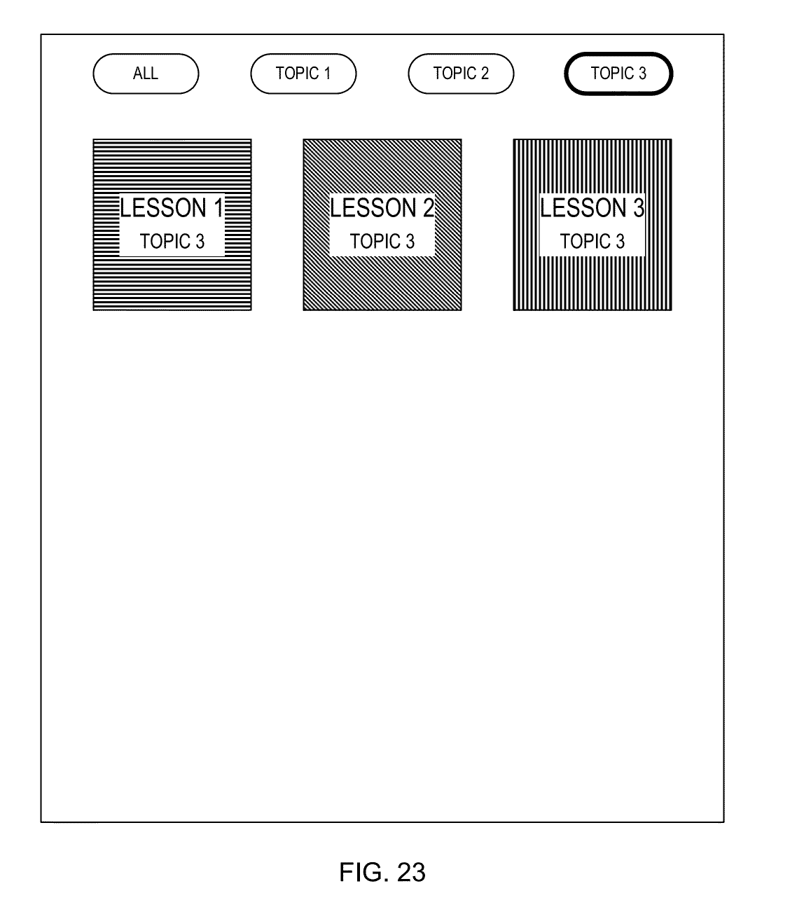

In response to a selection by the user of one of the topic buttons (block 2010), test preparation system 120 can reorder the selectable items from the first order to a second order according to the characteristic (e.g., topic) associated with the selected topic button (block 2020). An example of this is shown in FIG. 23, which depicts three items from the screen of FIG. 21 reordered by “Topic 3” in response to the selection of the “Topic 3” button at the top of the screen. Test preparation system 120 can achieve this reordering based on tagging associated the items that identifies which topics are associated with which items. In this manner, test preparation system 120 can match the items to be reordered to the characteristic associated with the selected button based on the tagging information.

Thus, in response to a selection by the user of another one of the topic buttons (block 2030), test preparation system 120 can reorder the selectable items again from the prior order to another order according to the characteristic (e.g., topic) associated with the selected topic button (block 2040). Test preparation system 120 can also provide a filtering function to the extent that an item not associated with the selected button characteristic can be omitted from the list of displayed items.

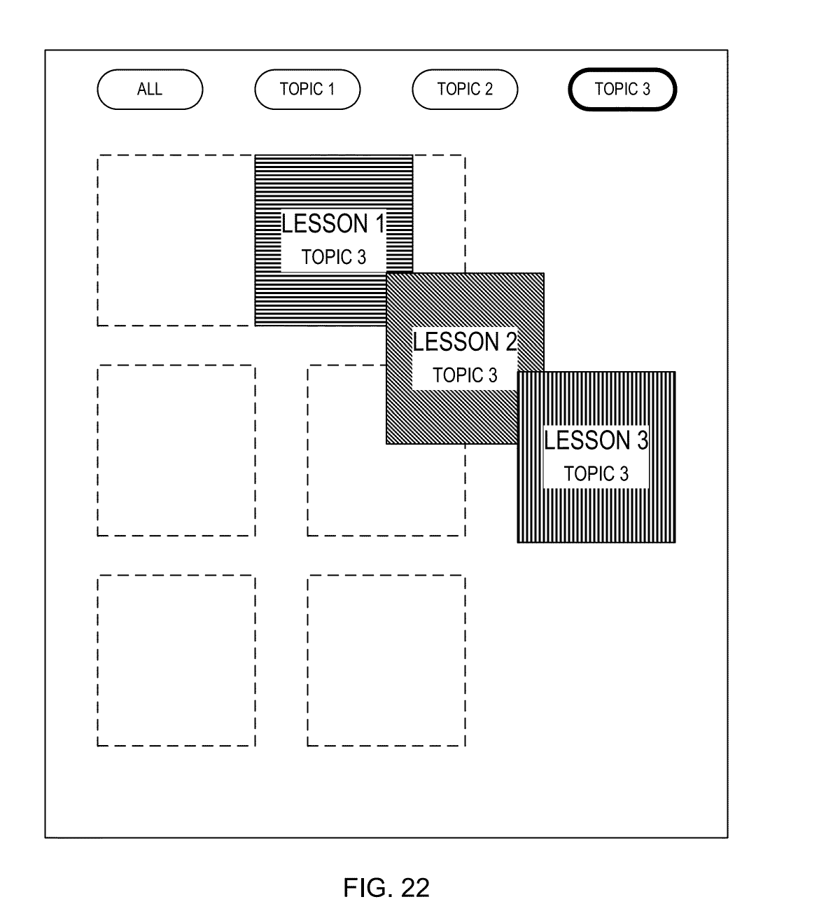

Test preparation system 120 can also render a transition effect during the reordering process. For example, as shown in FIG. 22, the transition effect can comprise a movement of the reordered items from their prior order position to their new order position. The transition effect can also comprise a fading out the items that are not reordered from the prior order position to the new order position, as shown by the broken line item outlines in FIG. 22.

Other effects can also be utilized to facilitate understanding of the characteristics of the items amid the reordering process. For example, a visual effect such as a shading or color can be used to identify a particular characteristic of the items, such as lesson number. Such effects can remain in place as the items are reordered. For example, as shown in FIGS. 21-23, horizontal shading is applied to all lesson 1 topics, diagonal shading to all lesson 2 topics and vertical shading to all lesson 3 topics. This shading remains in place even as the items are reordered by topic 3, so by glancing at the screen in FIG. 23 the user can appreciate that each of the items, though related by topic, belong to different lessons because the shading for each item is different.

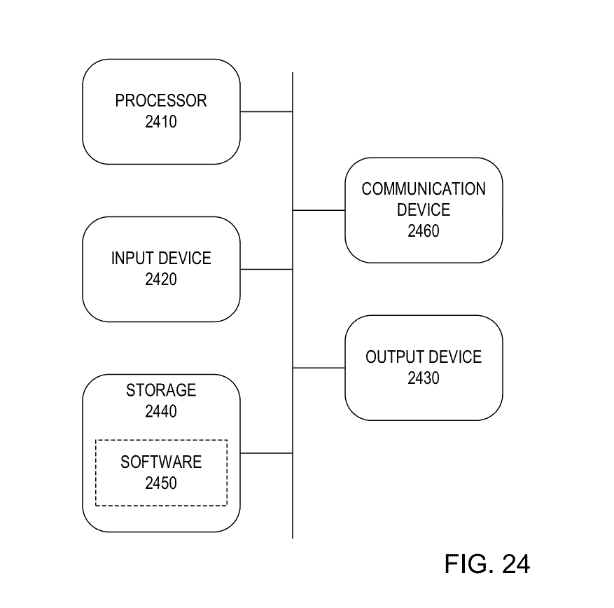

FIG. 24 shows a block diagram of an example of a computing device, which may generally correspond to server 100 and user 110. The form of computing device 2400 may be widely varied. For example, computing device 2400 can be a personal computer, workstation, server, handheld computing device, or any other suitable type of microprocessor-based device. Computing device 2400 can include, for example, one or more components including processor 2410, input device 2420, output device 2430, storage 2440, and communication device 2460. These components may be widely varied, and can be connected to each other in any suitable manner, such as via a physical bus, network line or wirelessly for example.

For example, input device 2420 may include a keyboard, mouse, touch screen or monitor, voice-recognition device, or any other suitable device that provides input. Output device 2430 may include, for example, a monitor, printer, disk drive, speakers, or any other suitable device that provides output.

Storage 2440 may include volatile and/or nonvolatile data storage, such as one or more electrical, magnetic or optical memories such as a RAM, cache, hard drive, CD-ROM drive, tape drive or removable storage disk for example. Communication device 2460 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 2450 can be stored in storage 2440 and executed by processor 2410, and may include, for example, programming that embodies the functionality described in the various embodiments of the present disclosure. The programming may take any suitable form. Software 2450 may include, for example, a combination of servers such as application servers and database servers.

Software 2450 can also be stored and/or transported within any computer-readable storage medium for use by or in connection with an instruction execution system, apparatus, or device, such as computing device 2400 for example, that can fetch instructions associated with the software from the instruction execution system, apparatus, or device and execute the instructions. In the context of this document, a computer-readable storage medium can be any medium, such as storage 2440 for example, that can contain or store programming for use by or in connection with an instruction execution system, apparatus, or device.

Software 2450 can also be propagated within any transport medium for use by or in connection with an instruction execution system, apparatus, or device, such as computing device 2400 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in multiple units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system comprising:
one or more servers configured to
display a first screen comprising a first portion of a problem and a first set of notations,
receive a first request to provide a solution to a second portion of the problem, and
display, in response to the first request, a second screen comprising the second portion of the problem, the first set of notations and a second set of notations.

2. The system of claim 1, wherein the first and second portions of the problem are specified in printed form.

3. The system of claim 2, wherein the first and second sets of notations are specified in handwritten form.

4. The system of claim 2, wherein the first and second sets of notations are specified in different colors.

5. The system of claim 1, wherein the first portion of the problem comprises a stimulus of the problem and the second portion of the problem comprises a question based on the stimulus.

6. The system of claim 5, wherein
the first set of notations comprises a deconstruction of the stimulus of the problem, and
the second set of notations comprises a deconstruction of the first set of notations to provide the solution to the question.

7. The system of claim 1, wherein the second screen superimposes the second set of notations on the first set of notations.

8. The system of claim 1 comprising one or more servers configured to
receive a second request to provide a solution to a third portion of the problem, and
display, in response to the second request, a third screen comprising the third portion of the problem, the first set of notations and a third set of notations and omitting the second set of notations.

9. The system of claim 1, wherein the first and second sets of notations are displayed statically.

10. The system of claim 1, wherein the first and second sets of notations are displayed dynamically.

11. The system of claim 1, wherein the first and second screens comprises a common screen size and are displayed independently of each other.

12. The system of claim 1, wherein the first set of notations is displayed in a common location in the first screen and the second screen.

13. A method comprising:
rendering a screen comprising a navigation area and a video display area, the navigation area comprising multiple buttons, each of the multiple buttons being associated with a distinct video file, and the video display area comprising a common area to play each of the video files; and
in response to a selection by a user of one of the rendered buttons, launching the video file associated with the selected button in the video display area without accessing the video files associated with the other of the rendered buttons.

14. The method of claim 13, comprising launching the video file associated with the selected button from a first software component and rendering the multiple buttons from a second software component that is not within the first software component.

15. The method of claim 13, wherein the multiple buttons are arranged linearly in the navigation area.

16. A system comprising:
one or more servers configured to
render a screen comprising multiple buttons in a first area of the screen and multiple selectable items in a second area of the screen, each of the multiple buttons being associated with a distinct characteristic associated with one or more of the selectable items, and the multiple selectable items being arranged in a first order,
receive a first selection by a user of a first one of the rendered buttons,
reorder, in response to the first selection, the rendered selectable items from the first order to a second order according to the characteristic associated with the selected first one of the rendered buttons.

17. The system of claim 16, comprising one or more servers configured to render a transition effect during the reorder from the first order to the second order.

18. The system of claim 17, wherein the transition effect comprises moving the reordered selectable items from their position in the first order to their position in the second order.

19. The system of claim 18, wherein the transition effect comprises fading out the selectable items that are not reordered from the first order to the second order.

20. The system of claim 16, comprising one or more servers configured to
receive a second selection by a user of a second one of the rendered buttons, and
reorder, in response to the second selection, the rendered selectable items from the second order to a third order according to the characteristic associated with the selected second one of the rendered buttons.
